(19) United States
(12) Patent Application Publication
(10) Pub. No.: US 2012/0328968 A1
(43) Pub. Date: Dec. 27, 2012

(54) FUEL CELL SYSTEM

(75) Inventor: Seiji HONDA, Wako (JP)

(73) Assignee: HONDA MOTOR CO., LTD., Tokyo (JP)

(21) Appl. No.: 13/517,596

(22) Filed: Jun. 14, 2012

(30) Foreign Application Priority Data
Jun. 22, 2011 (JP) 2011-138313

(51) Int. Cl. H01M 8/04

(52) U.S. Cl. 429/446; 429/444

(57) ABSTRACT

A fuel cell system includes a fuel cell, an air supply flow passage, an air exhaust flow passage, a compressor, an expander turbine, an electric motor, a dynamic pressure gas-lubricated bearing device, and a bearing air exhaust supply flow passage. The expander turbine is disposed in the air exhaust flow passage to generate driving energy using air output from the fuel cell. The expander turbine has a rotation shaft shared by the compressor. The electric motor is to rotate the rotation shaft. The dynamic pressure gas-lubricated bearing device is to support the rotation shaft using part of air discharged from the compressor as actuation air. Air passing through the dynamic pressure gas-lubricated bearing device is supplied to the expander turbine through the bearing air exhaust supply flow passage.

### CROSS-REFERENCE TO RELATED APPLICATIONS

The present application claims priority under 35 U.S.C. §119 to Japanese Patent Application No. 2011-138313, filed Jun. 22, 2011, entitled “Fuel Cell System.” The contents of this application are incorporated herein by reference in their entirety.

### BACKGROUND OF THE INVENTION

1. Field of the Invention

The present technology relates to a fuel cell system.

2. Discussion of the Background

In general, fuel cell systems including a fuel cell that generates electricity by receiving fuel and an oxidant compress air including oxygen serving as the oxidant using a compressor and supply the compressed air to the fuel cell. After using the air for generating electricity, the fuel cell systems discharge the air from the fuel cell to atmosphere.

In contrast, Japanese Unexamined Patent Application Publication Nos. 6-223851 and 2004-111127 describe a technology for effectively using energy by driving a turbine generator that uses the energy of air discharged from a fuel cell and recovering the energy in the form of electricity.

In addition, Japanese Unexamined Patent Application Publication No. 63-49022 describes a rotary machine including a compressor and a turbine coaxially connected with a rotation shaft supported by a dynamic pressure gas-lubricated bearing. In the rotary machine, a cooling flow passage for circulating part of air compressed by the compressor branches from an air exhaust passage for discharging the compressed air, and the bearing is cooled by the compressed air circulated in the cooling flow passage. Furthermore, Japanese Unexamined Patent Application Publication No. 63-49022 describes a technology in which a bearing air flow passage that directs air compressed by a compressor into a dynamic pressure gas-lubricated bearing is provided in a bearing casing, and the bearing air flow passage also serves as the above-described cooling flow passage.

The bearing air flow passage or the cooling flow passage is intended to be used to cool a bearing casing and a bearing unit using the compressed air circulated in the bearing air flow passage or the cooling flow passage in order to prevent an increase in the temperature of the bearing unit due to frictional heat generated by the rotation shaft rotating at high speed. In addition, the bearing air flow passage or the cooling flow passage is intended to be used to recover the heat retained in the compressed air having a temperature increased by the cooling and, thus, increase the system efficiency.

### SUMMARY OF THE INVENTION

According to one aspect of the present invention, a fuel cell system includes a fuel cell, an air supply flow passage, an air exhaust flow passage, a compressor, an expander turbine, an electric motor, a dynamic pressure gas-lubricated bearing device, and a bearing air exhaust supply flow passage. The fuel cell is to generate electricity from fuel and an oxidant. Air containing oxygen serving as the oxidant is supplied to the fuel cell through the air supply flow passage. Air output from the fuel cell is discharged through the air exhaust flow passage. The compressor is disposed in the air supply flow passage to compress air to deliver compressed air to the fuel cell. The expander turbine is disposed in the air exhaust flow passage to generate driving energy using the air output from the fuel cell. The expander turbine has a rotation shaft shared by the compressor. The electric motor is to rotate the rotation shaft. The dynamic pressure gas-lubricated bearing device is to support the rotation shaft using part of air discharged from the compressor as actuation air. Air passing through the dynamic pressure gas-lubricated bearing device is supplied to the expander turbine through the bearing air exhaust supply flow passage.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a block diagram of a fuel cell system according to an exemplary embodiment of the present technology.

FIG. 2 is a flowchart of open/close control of an on/off valve performed when driving of a compressor is started according to the exemplary embodiment.

FIG. 3 is a flowchart of open/close control of the on/off valve performed when a cathode pressure is reduced according to the exemplary embodiment.

### DESCRIPTION OF THE EMBODIMENTS

The embodiments will now be described with reference to the accompanying drawings, wherein like reference numerals designate corresponding or identical elements throughout the various drawings.

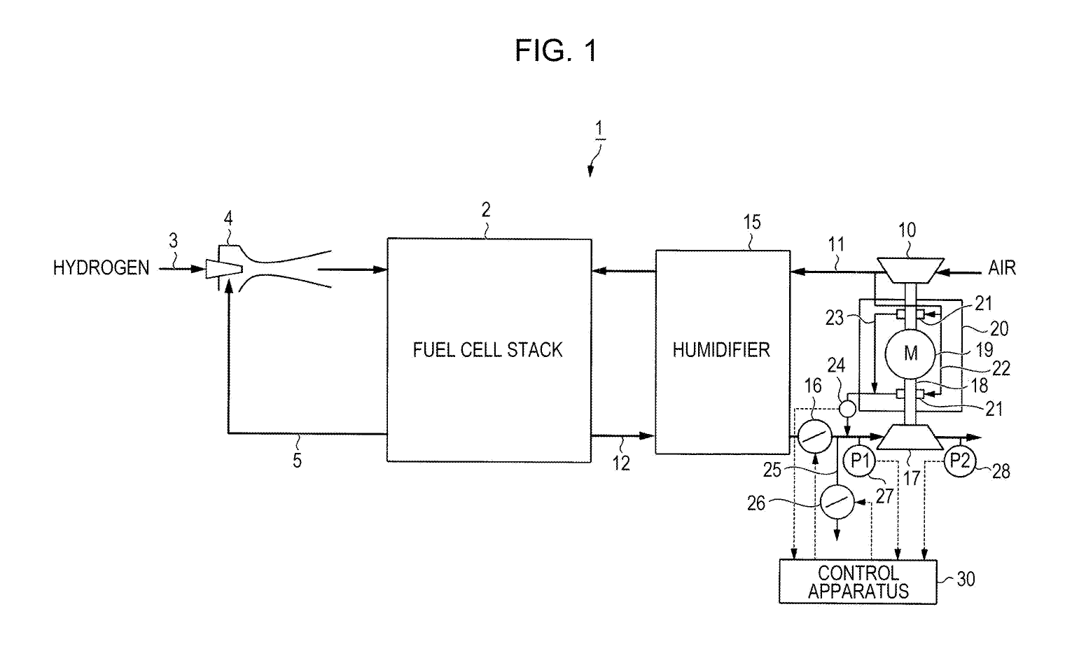

A fuel cell system according to an exemplary embodiment of the present technology is described below with reference to FIGS. 1 to 3. Note that according to the present exemplary embodiment, the fuel cell system is mounted in a fuel-cell vehicle. FIG. 1 is a block diagram of a fuel cell system 1 according to the present exemplary embodiment. A fuel cell stack (fuel cell) 2 includes a plurality of stacked cells each having a solid polymer electrolyte membrane (e.g., a solid polymer ion-exchange membrane) sandwiched by an anode and a cathode. Hydrogen (fuel) is supplied to the anode, and air including oxygen serving as an oxidant is supplied to the cathode. Thus, hydrogen ions generated on the anode due to a catalyst action pass through the solid polymer electrolyte membrane and reach the cathode. The hydrogen ions undergo electrochemical reaction with oxygen contained in the air. Thus, electricity is generated. In addition, water is generated.

Hydrogen stored in a hydrogen tank (not illustrated) is supplied to the anode of the fuel cell stack 2 via a hydrogen supply flow passage 3 and an ejector 4. The hydrogen unreacted and unconsumed in the fuel cell stack 2 is discharged from the fuel cell stack 2 in the form of anode offgas. The anode offgas flows through an anode offgas flow passage 5 and returns to the ejector 4. Thereafter, the anode offgas merges into fresh hydrogen supplied from the hydrogen tank and is supplied to the anode of the fuel cell stack 2 again.

The air is pressurized by a compressor 10. Thereafter, the air flows through an air supply flow passage 11 and is supplied to the cathode of the fuel cell stack 2. The oxygen contained in the air is supplied for generating electricity. Subsequently, the air is discharged from the fuel cell stack 2 in the form of cathode offgas and flows through a cathode offgas flow passage (an air exhaust flow passage) 12. Thereafter, the cathode offgas is discharged. As used herein, the air supplied to the fuel cell stack 2 is referred to as “supply air”.

The air supply flow passage 11 includes a humidifier 15 disposed downstream of the compressor 10. The humidifier 15 is located between the air supply flow passage 11 and the cathode offgas flow passage 12. The humidifier 15 humidifies the supply air by moving the moisture contained in the cathode offgas into the supply air through a membrane. That is, the humidifier 15 is formed as a membrane humidifier.

In the cathode offgas flow passage 12, a pressure control valve 16 and an expander turbine 17 are disposed downstream of the humidifier 15 in this order. The pressure control valve 16 is used to control the air pressure applied to the cathode in the fuel cell stack 2 (hereinafter referred to as a “cathode pressure”) by varying the opening level thereof. The compressor 10 is coaxially connected to the expander turbine 17 by a rotation shaft 18. The rotation shaft 18 is driven and rotated by a drive motor (an electric motor) 19. The compressor 10 is driven by the drive motor 19 and the expander turbine 17 that is driven by the energy of the cathode offgas.

The rotation shaft 18 is coupled with the output shaft of the drive motor 19. One end of the rotation shaft 18 protrudes from a motor casing 20. The compressor 10 is connected to the end of the rotation shaft 18. The expander turbine 17 is connected to the other end of the rotation shaft 18. The rotation shaft 18 is rotatably supported by the motor casing 20 using a dynamic pressure gas-lubricated bearing unit 21 provided in the motor casing 20.

The motor casing 20 further includes a bearing air inlet flow passage 22 for directing the air compressed by the compressor 10 into the dynamic pressure gas-lubricated bearing unit 21 and a bearing air exhaust supply flow passage 23 for discharging the air circulated in the dynamic pressure gas-lubricated bearing unit 21 and supplying the air to the expander turbine 17. The bearing air inlet flow passage 22 is connected to the air supply flow passage 11 between the compressor 10 and the humidifier 15. The bearing air exhaust supply flow passage 23 is connected to the cathode offgas flow passage 12 between the pressure control valve 16 and the expander turbine 17. In this way, part of the air compressed by the compressor 10 (hereinafter, the air is referred to as “bearing air”) is supplied to the dynamic pressure gas-lubricated bearing unit 21 via the bearing air inlet flow passage 22 and serves as the air that operates the dynamic pressure gas-lubricated bearing unit 21. The bearing air circulated in the dynamic pressure gas-lubricated bearing unit 21 is dischargeable to the cathode offgas flow passage 12 via the bearing air exhaust supply flow passage 23.

Between a branch point at which the bearing air inlet flow passage 22 branches from the air supply flow passage 11 and a merge point at which the bearing air exhaust supply flow passage 23 merges into the cathode offgas flow passage 12, the length of a flow passage that passes through the bearing air inlet flow passage 22, the dynamic pressure gas-lubricated bearing unit 21, and the bearing air exhaust supply flow passage 23 is set to be shorter than the length of a flow passage that passes through the air supply flow passage 11, the fuel cell stack 2, and the cathode offgas flow passage 12. Thus, the flow resistance of the former flow passage is smaller than that of the latter flow passage. The bearing air exhaust supply flow passage 23 includes an airflow sensor 24 that detects the flow rate of the bearing air.

In the cathode offgas flow passage 12, an air release flow passage 25 having an end that is open to the atmosphere branches from a point between the pressure control valve 16 and the expander turbine 17. The air release flow passage 25 includes an on/off valve 26. Note that the on/off valve 26 is normally closed. In the cathode offgas flow passage 12, a turbine intake pressure sensor 27 for detecting the cathode offgas pressure at the intake of the expander turbine 17 (hereinafter referred to as a “turbine intake pressure”) is disposed between the pressure control valve 16 and the expander turbine 17. In the cathode offgas flow passage 12, a turbine exhaust pressure sensor 28 for detecting a cathode offgas pressure at the exhaust of the expander turbine 17 (hereinafter referred to as a “turbine exhaust pressure”) is disposed immediately downstream of the expander turbine 17. Each of the airflow sensor 24, the turbine intake pressure sensor 27, and the turbine exhaust pressure sensor 28 outputs an electric signal to a control apparatus (a control unit) 30 in accordance with a detection value.

The control apparatus 30 performs an open/close control on the on/off valve 26 on the basis of the outputs of the airflow sensor 24, the turbine intake pressure sensor 27, and the turbine exhaust pressure sensor 28. In addition, the control apparatus 30 performs, for example, rotational speed control on the drive motor 19 and opening level control on the pressure control valve 16 on the basis of the required amount of electricity.

In this embodiment, the control apparatus 30 is configured to electrically perform the open/close control on the on/off valve 26, to electrically perform the rotational speed control on the drive motor 19, and to electrically perform the opening level control on the pressure control valve 16. However, the control apparatus 30 may be configured to mechanically perform the open/close control on the on/off valve 26 by transmitting force to the on/off valve 26, or to electrically and mechanically perform the open/close control on the on/off valve 26. The control apparatus 30 may be configured to mechanically perform the rotational speed control on the drive motor 19 by transmitting force to the drive motor 19, or to electrically and mechanically perform the rotational speed control on the drive motor 19. The control apparatus 30 may be configured to mechanically perform the opening level control on the pressure control valve 16 by transmitting force to the pressure control valve 16, or to electrically and mechanically perform the opening level control on the pressure control valve 16.

According to the fuel cell system 1, throughout the operation performed by the compressor 10, part of the compressed air having a pressure increased by the compressor 10 serves as bearing air, flows through the bearing air inlet flow passage 22, and is supplied to the dynamic pressure gas-lubricated bearing unit 21. Thereafter, the bearing air flows through the bearing air exhaust supply flow passage 23 and is discharged to the cathode offgas flow passage 12. The bearing air merges into the cathode offgas discharged from the cathode of the fuel cell stack 2 and is supplied to the expander turbine 17.

While the bearing air is flowing in the bearing air inlet flow passage 22, the dynamic pressure gas-lubricated bearing unit 21, and the bearing air exhaust supply flow passage 23, the bearing air absorbs the friction heat generated when the rotation shaft 18 rotates at high speed. Thus, the bearing air cools the dynamic pressure gas-lubricated bearing unit 21 and the motor casing 20. In addition, since the bearing air is supplied to the expander turbine 17 together with the cathode offgas discharged from the fuel cell stack 2, the energy of the bearing air can be recovered in the form of the energy that drives the expander turbine 17. As a result, the power generation efficiency of the fuel cell system 1 can be increased.

When driving of the compressor 10 is started (e.g., when the fuel cell system 1 is started), it takes time before the supply air is delivered to the fuel cell stack 2, is discharged from the fuel cell stack 2 as the cathode offgas, and is directed into the expander turbine 17. In addition, since the kinetic energy of the cathode offgas is small, time lag occurs in driving and rotating the expander turbine 17 (hereinafter such time lag is referred to as a “turbo lag”).

However, in the fuel cell system 1 according to the present exemplary embodiment, when driving of the compressor 10 is started, part of the air compressed by the compressor 10 serves as the bearing air that flows through the bearing air inlet flow passage 22, the dynamic pressure gas-lubricated bearing unit 21, and the bearing air exhaust supply flow passage 23 and is discharged into the cathode offgas flow passage 12 disposed immediately upstream of the expander turbine 17. Accordingly, the bearing air can be supplied to the expander turbine 17 before the cathode offgas discharged from the fuel cell stack 2 is supplied to the expander turbine 17. As a result, the turbo lag can be reduced and, therefore, the expander turbine 17 can be quickly driven and rotated. Consequently, the power consumption of the drive motor 19 can be reduced and, therefore, the power generation efficiency of the fuel cell system 1 can be increased.

In addition, in order to further reduce the turbo lag, the fuel cell system 1 opens the on/off valve 26 of the air release flow passage 25 immediately after the compressor 10 is started. When the compressor 10 is driven, the expander turbine 17 that has the rotation shaft 18 coupled with the rotation shaft of the compressor 10 is also rotated. Accordingly, immediately after the compressor 10 is started, the pressure at the intake of the expander turbine 17 is made lower than the pressure at the exhaust of the expander turbine 17 by the pumping operation performed by the expander turbine 17. Thus, the difference in the pressure causes the rotational resistance of the expander turbine 17.

According to the present exemplary embodiment, when the compressor 10 is started and if the intake pressure of the expander turbine 17 is lower than or equal to the exhaust pressure of the expander turbine 17, the on/off valve 26 is made open. Thus, the atmospheric pressure is communicated to the intake of the expander turbine 17 and, therefore, the difference between the pressures is reduced. At the same time, as described above, the bearing air is introduced into the upstream of the expander turbine 17. Accordingly, the turbo lag can be further reduced and, therefore, the power generation efficiency of the fuel cell system 1 can be further increased.

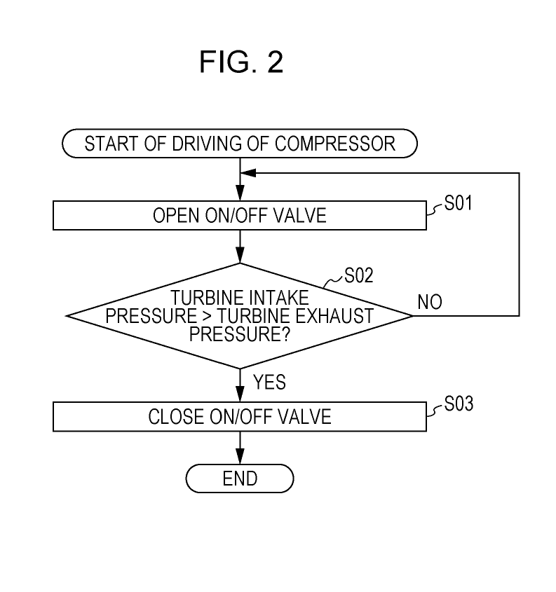

The open/close control of the on/off valve 26 performed when the compressor 10 is started is described below with reference to a flowchart illustrated in FIG. 2. The open/close control routine of the on/off valve 26 illustrated in the flowchart of FIG. 2 is performed by the control apparatus 30. When driving of the drive motor 19 is started and, thus, driving of the compressor 10 is started, the on/off valve 26 is made open in step S01. Thus, the atmospheric pressure is communicated to the cathode offgas flow passage 12 disposed upstream of the expander turbine 17 via the air release flow passage 25. Subsequently, the processing proceeds to step S02, where the turbine intake pressure detected by the turbine intake pressure sensor 27 is compared with the turbine exhaust pressure detected by the turbine exhaust pressure sensor 28. In this way, it is determined whether the turbine intake pressure is higher than the turbine exhaust pressure.

If the determination made in step S02 is “NO” (if the turbine intake pressure the turbine exhaust pressure), the processing returns to step S01, where the on/off valve 26 is maintained open. However, if the determination made in step S02 is “YES” (if the turbine intake pressure >the turbine exhaust pressure), the processing proceeds to step S03, where the on/off valve 26 is closed and, thereafter, introduction of the atmospheric air into the cathode offgas flow passage 12 disposed upstream of the expander turbine 17 is completed. In this way, useless introduction of the atmospheric air can be prevented. By performing the open/close control of the on/off valve 26 in this manner, the turbo lag can be further reduced.

In addition, if a reduction in the cathode pressure of the fuel cell stack 2 is requested depending on the operating condition of the fuel cell system 1, the cathode pressure is reduced by decreasing the voltage applied to the drive motor 19 and, thus, decreasing the rotational speed of the drive motor 19 and increasing the opening level of the pressure control valve 16. At that time, although the pressure control valve 16 is fully open, the exhaust speed is reduced due to a pressure drop in the expander turbine 17 as compared with the case in which the expander turbine 17 is not provided. Thus, the delay of the response to the request for a reduction in pressure is increased. In such a case, the differential pressure applied to the solid polymer electrolyte membrane in the cell cannot be maintained within a predetermined range unless the delay of the response to the request for a reduction in pressure of the anode of the fuel cell stack 2 is increased. Thus, the risk of a decrease in the power generation efficiency may increase.

However, according to the fuel cell system 1, throughout the operation performed by the compressor 10, part of the air compressed by the compressor 10 serves as the bearing air. The bearing air is discharged to the cathode offgas flow passage 12 disposed immediately upstream of the expander turbine 17 via the bearing air inlet flow passage 22, the dynamic pressure gas-lubricated bearing unit 21, and the bearing air exhaust supply flow passage 23. Accordingly, when a reduction in the cathode pressure of the fuel cell stack 2 is requested, the bearing air is supplied to the upstream of the expander turbine 17. Thus, the dynamic pressure at the intake of the turbine increases and, therefore, the exhaust velocity can be increased. As a result, the response time to a reduction in the pressure can be reduced. Accordingly, the power generation efficiency is not reduced. In addition, if the rotational speed of the rotation shaft 18 is reduced by reducing the rotational speed of the drive motor 19 in response to a request for reduction in the pressure, the reduction in speed is prevented by the inertia of the expander turbine 17.

However, according to the present exemplary embodiment, when a decrease in the cathode pressure of the fuel cell stack 2 is requested and, thus, control is performed so that the rotational speed of the drive motor 19 is reduced by decreasing the voltage applied to the drive motor 19 and the opening level of the pressure control valve 16 is increased and if the flow rate of the bearing air is reduced to less than a predetermined value and the turbine intake pressure is lower than the turbine exhaust pressure, the on/off valve 26 is made open. Thus, the cathode offgas and the bearing air output from the fuel cell stack 2 are discharged via the air release flow passage 25 without passing through the expander turbine 17. In this way, the delay of the response to the request to a reduction in the pressure can be further reduced.

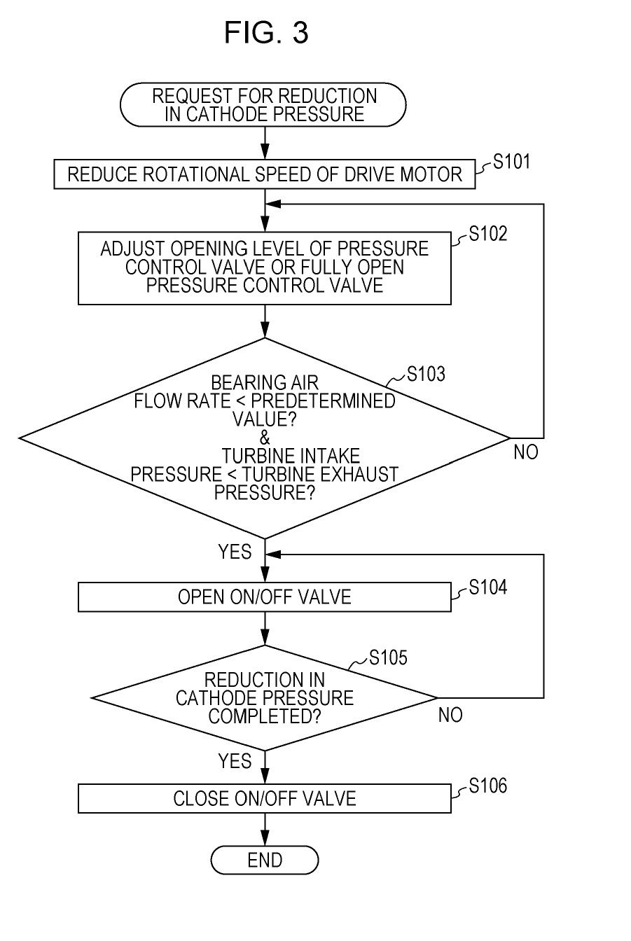

The open/close control of the on/off valve 26 performed when the cathode pressure is reduced is described below with reference to a flowchart illustrated in FIG. 3. The open/close control routine of the on/off valve 26 illustrated in the flowchart of FIG. 3 is performed by the control apparatus 30. When a request to reduce the cathode pressure of the fuel cell stack 2 is received, the rotational speed of the drive motor 19 is reduced in step S101 by decreasing the voltage applied to the drive motor 19 in accordance with the requested reduction in the pressure. Thus, the rotational speed of the compressor 10 and the expander turbine 17 is reduced. Subsequently, the processing proceeds to step S102, where the opening level of the pressure control valve 16 is controlled in accordance with the requested reduction in the pressure. The maximum opening level for the open/close control is the full open level of the pressure control valve 16.

Subsequently, the processing proceeds to step S103, where it is determined whether the flow rate of the bearing air detected by the airflow sensor 24 is lower than a predetermined value and the turbine intake pressure detected by the turbine intake pressure sensor 27 is lower than the turbine exhaust pressure detected by the turbine exhaust pressure sensor 28. If the determination made in step S103 is “NO”, that is, if the flow rate of the bearing air is higher than or equal to the predetermined value or if the turbine intake pressure is higher than or equal to the turbine exhaust pressure, the processing returns to step S102. In step S102, the opening level of the pressure control valve 16 is continuously controlled.

However, if the determination made in step S103 is “YES”, that is, when the flow rate of the bearing air is lower than the predetermined value and if the turbine intake pressure is lower than the turbine exhaust pressure, the processing proceeds to step S104. In step S104, the on/off valve 26 is made open. The cathode offgas and the bearing air output from the fuel cell stack 2 are discharged to the atmosphere via the air release flow passage 25 without passing through the expander turbine 17. In this way, the delay of the response to a request for a reduction in the pressure can be further reduced.

Subsequently, the processing proceeds to step S105, where it is determined whether the processing for the request to reduce the cathode pressure is completed. If the determination made in step S105 is “NO”, the processing returns to step S104, where the on/off valve 26 is continuously made open. However, the determination made in step S105 is “YES”, the processing proceeds to step S106, where the on/off valve 26 is closed.

According to an embodiment of the present technology, a fuel cell system (e.g., the fuel cell system 1 according to the exemplary embodiment) includes a fuel cell (e.g., the fuel cell stack 2 according to the exemplary embodiment) that receives fuel and an oxidant and generates electricity, an air supply flow passage (e.g., the air supply flow passage 11 according to the exemplary embodiment) that allows air containing oxygen serving as the oxidant to pass therethrough and be supplied to the fuel cell, an air exhaust flow passage (e.g., the cathode offgas flow passage 12 according to the exemplary embodiment) that discharges air output from the fuel cell, a compressor (e.g., the compressor 10 according to the exemplary embodiment) disposed in the air supply flow passage, where the compressor compresses air and delivers the compressed air to the fuel cell, an expander turbine (e.g., the expander turbine 17 according to the exemplary embodiment) disposed in the air exhaust flow passage, where the expander turbine has a rotation shaft (e.g., the rotation shaft 18 according to the exemplary embodiment) that is shared by the compressor and uses the air output from the fuel cell as driving energy, an electric motor (e.g., the drive motor 19 according to the exemplary embodiment) mounted on the rotation shaft, a dynamic pressure gas-lubricated bearing unit (e.g., the dynamic pressure gas-lubricated bearing unit 21 according to the exemplary embodiment) that supports the rotation shaft by branching the air discharged from the compressor and using part of the air as actuation air, and a bearing air exhaust supply flow passage (e.g., the bearing air exhaust supply flow passage 23 according to the exemplary embodiment) that directs the air circulated in the dynamic pressure gas-lubricated bearing unit to the expander turbine. In the embodiment, since part of the air compressed by the compressor is supplied to the dynamic pressure gas-lubricated bearing unit and is supplied to the expander turbine through the bearing air exhaust supply flow passage at all times while the compressor is being driven, the energy of the air can be recovered in the form of the energy for driving the expander turbine. As a result, the power generation efficiency of the fuel cell system can be increased. In addition, when driving of the compressor is started, the air circulated in the dynamic pressure gas-lubricated bearing unit can be supplied to the expander turbine before the air discharged from the fuel cell is supplied to the expander turbine. Accordingly, a time lag of driving and rotating the expander turbine can be decreased. In addition, when the cathode pressure is reduced, the air circulated in the dynamic pressure gas-lubricated bearing unit is supplied to the expander turbine. Accordingly, the dynamic pressure at the intake of the expander turbine can be increased and, therefore, the exhaust velocity can be increased. Thus, a quick response to a request for reduction in pressure can be provided.

The fuel cell system can further include an air release flow passage (e.g., the air release flow passage 25 according to the exemplary embodiment) connected between the fuel cell and the expander turbine in the air exhaust flow passage. The air release flow passage has one end that is open to atmosphere, and the air release flow passage includes an on/off valve (e.g., the on/off valve 26 according to the exemplary embodiment). By opening the on/off valve, the atmospheric pressure can be communicated to the intake of the expander turbine.

The fuel cell system can further include a turbine intake pressure sensor (e.g., the turbine intake pressure sensor 27 according to the exemplary embodiment) that detects an air pressure at an intake of the expander turbine, a turbine exhaust pressure sensor (e.g., the turbine exhaust pressure sensor 28 according to the exemplary embodiment) that detects an air pressure at an exhaust of the expander turbine, and a control unit (e.g., the control apparatus 30 according to the exemplary embodiment). When driving of the compressor is started, the control unit can start driving of the electric motor and open the on/off valve. If the air pressure at the intake detected by the turbine intake pressure sensor is higher than the air pressure at the exhaust detected by the turbine exhaust pressure sensor, the control unit can close the on/off valve. By opening the on/off valve when driving of the compressor is started, the atmospheric pressure can be communicated to the intake of the expander turbine and, thus, a time lag of driving and rotating the expander turbine can be further decreased. In addition, by closing the on/off valve when the air pressure at the intake of the expander turbine is higher than the air pressure at the exhaust of the expander turbine, unnecessary air introduction can be prevented.

The fuel cell system can further include a pressure control valve (e.g., the pressure control valve 16 according to the exemplary embodiment described below) disposed in the air exhaust flow passage, where the pressure control valve controls a cathode pressure of the fuel cell, an airflow sensor (e.g., the airflow sensor 24 according to the exemplary embodiment) that detects a flow rate of the air circulated in the bearing air exhaust supply flow passage, a turbine intake pressure sensor (e.g., the turbine intake pressure sensor 27 according to the exemplary embodiment) that detects an air pressure at an intake of the expander turbine, a turbine exhaust pressure sensor (e.g., the turbine exhaust pressure sensor 28 according to the exemplary embodiment) that detects an air pressure at an exhaust of the expander turbine, and a control unit (e.g., the control apparatus 30 according to the exemplary embodiment). The control unit opens the pressure control valve in order to reduce the cathode pressure of the fuel cell. When the flow rate detected by the airflow sensor is lower than a predetermined value and if the air pressure at the intake detected by the turbine intake pressure sensor is lower than the air pressure at the exhaust detected by the turbine exhaust pressure sensor, the control unit opens the on/off valve. By opening the on/off valve when the flow rate of the air flowing in the dynamic pressure gas-lubricated bearing unit is lower than a predetermined value and if the air pressure at the intake of the expander turbine is lower than the air pressure at the exhaust of the expander turbine while decreasing the cathode pressure of the fuel cell, the air output from the fuel cell and the air circulated in the dynamic pressure gas-lubricated bearing unit can be discharged via the air release flow passage without passing the air through the expander turbine. Thus, a further quick response to a request for reduction in pressure can be provided.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell system comprising:
a fuel cell to generate electricity from fuel and an oxidant;
an air supply flow passage through which air containing oxygen serving as the oxidant is supplied to the fuel cell;
an air exhaust flow passage through which air output from the fuel cell is discharged;
a compressor disposed in the air supply flow passage to compress air to deliver compressed air to the fuel cell;
an expander turbine disposed in the air exhaust flow passage to generate driving energy using the air output from the fuel cell, the expander turbine having a rotation shaft shared by the compressor;
an electric motor to rotate the rotation shaft;
a dynamic pressure gas-lubricated bearing device to support the rotation shaft using part of air discharged from the compressor as actuation air; and
a bearing air exhaust supply flow passage through which air passing through the dynamic pressure gas-lubricated bearing device is supplied to the expander turbine.

2. The fuel cell system according to claim 1, further comprising:
an air release flow passage connected to the air exhaust flow passage between the fuel cell and the expander turbine, the air release flow passage having one end that is open to atmosphere, the air release flow passage including an on/off valve to discharge air from the air exhaust flow passage to the atmosphere.

3. The fuel cell system according to claim 2, further comprising:
a turbine intake pressure sensor configured to detect an intake air pressure at an intake of the expander turbine;
a turbine exhaust pressure sensor configured to detect an exhaust air pressure at an exhaust of the expander turbine; and
a controller opening the on/off valve if driving of the compressor is started by driving the electric motor, the controller closing the on/off valve if the intake air pressure detected by the turbine intake pressure sensor is higher than the exhaust air pressure detected by the turbine exhaust pressure sensor.

4. The fuel cell system according to claim 2, further comprising:
a pressure control valve disposed in the air exhaust flow passage to control a cathode pressure of the fuel cell;
an airflow sensor configured to detect a flow rate of the air passing through the bearing air exhaust supply flow passage;
a turbine intake pressure sensor configured to detect an intake air pressure at an intake of the expander turbine;
a turbine exhaust pressure sensor configured to detect an exhaust air pressure at an exhaust of the expander turbine; and
a controller configured to open the pressure control valve to reduce the cathode pressure of the fuel cell, the controller opening the on/off valve if the flow rate detected by the airflow sensor is lower than a predetermined value and if the intake air pressure detected by the turbine intake pressure sensor is lower than the exhaust air pressure detected by the turbine exhaust pressure sensor.

5. The fuel cell system according to claim 2, further comprising:
a turbine intake pressure sensor configured to detect an intake air pressure at an intake of the expander turbine;
a turbine exhaust pressure sensor configured to detect an exhaust air pressure at an exhaust of the expander turbine; and
controlling means for opening the on/off valve if driving of the compressor is started by driving the electric motor, and for closing the on/off valve if the intake air pressure detected by the turbine intake pressure sensor is higher than the exhaust air pressure detected by the turbine exhaust pressure sensor.

6. The fuel cell system according to claim 2, further comprising:
a pressure control valve disposed in the air exhaust flow passage to control a cathode pressure of the fuel cell;
an airflow sensor configured to detect a flow rate of the air passing through the bearing air exhaust supply flow passage;
a turbine intake pressure sensor configured to detect an intake air pressure at an intake of the expander turbine;
a turbine exhaust pressure sensor configured to detect an exhaust air pressure at an exhaust of the expander turbine; and
controlling means for opening the pressure control valve to reduce the cathode pressure of the fuel cell, and for opening the on/off valve if the flow rate detected by the airflow sensor is lower than a predetermined value and if the intake air pressure detected by the turbine intake pressure sensor is lower than the exhaust air pressure detected by the turbine exhaust pressure sensor.
